(19) United States
(12) Patent Application Publication
(10) Pub. No.: US 2024/0176125 A1
(43) Pub. Date: May 30, 2024

(54) METHOD AND SYSTEM FOR MANIPULATING PARTICLE BY USING OPTICAL TWEEZER

(71) Applicant: KOREA ADVANCED INSTITUTE OF SCIENCE AND TECHNOLOGY, Daejeon (KR)

(72) Inventors: Jaewook AHN, Daejeon (KR); Hansub HWANG, Daejeon (KR); Woojeong BYUN, Daejeon (KR)

(73) Assignee: KOREA ADVANCED INSTITUTE OF SCIENCE AND TECHNOLOGY, Daejeon (KR)

(21) Appl. No.: 18/522,600

(22) Filed: Nov. 29, 2023

(30) Foreign Application Priority Data
Nov. 29, 2022 (KR) 10-2022-0163448
Jun. 14, 2023 (KR) 10-2023-0076328

(51) Int. Cl. G02B 21/32; G21K 1/00

(52) U.S. Cl. CPC G02B 21/32; G21K 1/006

(57) ABSTRACT

Provided is a method and system for manipulating a particle by using an optical tweezer. The method includes accelerating the optical tweezer in which the particle is trapped, turning off the optical tweezer, and to catch the particle thrown by the optical tweezer that is turned off, turning on and decelerating the optical tweezer.

### CROSS-REFERENCE TO RELATED APPLICATION

This application claims the benefit of Korean Patent Application No. 10-2022-0163448, filed on Nov. 29, 2022, in the Korean Intellectual Property Office, and Korean Patent Application No. 10-2023-0076328, filed on Jun. 14, 2023, in the Korean Intellectual Property Office, the disclosures of which are incorporated herein in their entirety by reference.

### BACKGROUND

### 1. Field

The disclosure relates to a method and system for manipulating a particle by using an optical tweezer. More particularly, the disclosure relates to a method of manipulating a particle, such as throwing, catching, rearranging, and the like of a particle, by using an optical tweezer.

### 2. Description of the Related Art

Optical tweezers are instruments for trapping a microscopic particle. A force by which an optical tweezer traps a microscopic particle is generated from a scattering force of a laser beam having a focused intensity. The momentum conservation of the momentum of photons by a focused laser beam and the momentum of a microscopic particle by scattered photons provides a force that pushes the microscopic particle toward a central axis of the focused laser beam.

Optical tweezers are used for movement of various microscopic particles, such as DNA, protein, atoms, and the like. A method of moving an optical tweezer when trapping a microscopic particle by using the optical tweezer is used to move the microscopic particle. The method has a problem in that, when there is an obstacle, such as another microscopic particle, another optical tweezer, or the like, in the path of the microscopic particle, the movement of the microscopic particle is restricted by the obstacle.

### SUMMARY

Provided is a method and system for manipulating a particle by using an optical tweezer.

According to an aspect of the disclosure, provided is a method of manipulating a particle by using an optical tweezer.

According to an embodiment, a method of manipulating a particle by using an optical tweezer includes accelerating the optical tweezer in which the particle is trapped, turning off the optical tweezer, and to catch the particle thrown by the optical tweezer that is turned off, turning on and decelerating the optical tweezer.

According to an embodiment, a method of manipulating a particle by using an optical tweezer includes accelerating the optical tweezer in which the particle is trapped, reducing a depth of a potential well of the optical tweezer, and to catch the particle thrown by the optical tweezer in which the depth of the potential well is reduced, increasing the depth of the potential well of the optical tweezer and decelerating the optical tweezer.

According to an embodiment, a method of manipulating a particle by using an optical tweezer includes accelerating the optical tweezer in which he particle is trapped, toward at least one other particle, turning off the optical tweezer, and to catch the particle thrown by the optical tweezer that is turned off and moving through another at least one other particle, turning on and decelerating the optical tweezer.

According to an embodiment, a method of manipulating a particle by using an optical tweezer includes throwing a particle trapped in the optical tweezer by accelerating and turning on an optical tweezer, and catching the particle that is thrown by turning on and decelerating the optical tweezer.

According to an embodiment, a method of manipulating a particle by using an optical tweezer includes accelerating the optical tweezer in which a particle is trapped in a direction crossing a traveling direction of a laser beam of the optical tweezer, and turning off the optical tweezer.

According to an embodiment, a method of catching, by using an optical tweezer, a particle that flies includes turning on the optical tweezer to allow the particle that flies to be located therein, and decelerating the optical tweezer in a flight direction of the particle.

According to an embodiment, a method of manipulating a particle by using an optical tweezer includes reducing a depth of a potential well of the optical tweezer in which the particle is trapped, moving the optical tweezer with a reduced depth of the potential well to move the particle, and increasing the depth of the potential well of the optical tweezer that is moved.

According to another aspect of the disclosure, provided is a system for manipulating a particle by using an optical tweezer.

According to an embodiment, a system for manipulating a particle by using an optical tweezer includes an optical modulator configured to control the optical tweezer by interfering a laser beam with a pulse, and a processor configured to control the optical modulator, wherein the processor may be further configured to increase an increment of a frequency of the pulse of the optical modulator to accelerate the optical tweezer in which the particle is trapped, reduce an amplitude of the pulse of the optical modulator to allow the particle to be thrown by the optical tweezer that is turned off, and increase the amplitude of the pulse of the optical modulator and reduce the increment of the frequency of the pulse to allow the particle that is thrown to be caught by the optical tweezer.

According to an embodiment, a system for manipulating a particle by using an optical tweezer includes a laser source, an optical modulator configured to control the optical tweezer by interfering a laser beam output from the laser source with a pulse, and a processor configured to control the laser source and the optical modulator, wherein the processor may be further configured to increase an increment of a frequency of a pulse of the optical modulator to accelerate the optical tweezer in which the particle is trapped, stop an output of the laser source to allow the particle to be thrown by the optical tweezer that is turned off, and resume the output of the laser source and reduce the increment of the frequency of the pulse to allow the particle that is thrown to be caught by the optical tweezer.

### BRIEF DESCRIPTION OF THE DRAWINGS

These and/or other aspects will become apparent and more readily appreciated from the following description of the embodiments, taken in conjunction with the accompanying drawings in which:

FIG. 1 is a view for explaining an optical tweezer according to an embodiment;

FIG. 2 is a view for explaining a potential well of an optical tweezer according to an embodiment;

FIG. 3 is a view for explaining cases in which a particle is manipulated by first and second optical tweezers, according to an embodiment;

FIG. 4 is a view for explaining throwing and catching of a particle, by section, according to an embodiment;

FIG. 5 is a view for explaining a potential well of an optical tweezer, section by section, according to an embodiment;

FIG. 6 is a view for explaining the maximum acceleration of an optical tweezer, according to an embodiment;

FIG. 7 is a view for explaining the movement of a particle, according to an embodiment;

FIG. 8 is a success probability graph of throwing and catching of a particle, according to an embodiment;

FIG. 9 is a view for explaining a particle moving through at least one other particle, according to an embodiment;

FIGS. 10A to 10C are views for explaining the rearrangement of a particle array, according to some embodiments;

FIG. 11 is a success probability graph of the rearrangement of a particle array, according to an embodiment;

FIGS. 12 to 14 are block diagrams showing systems according to some embodiments;

FIG. 15 is a graph showing the control of an optical modulator, according to an embodiment;

FIGS. 16 and 17 are graphs showing the movement of an optical tweezer, according to some embodiments;

FIG. 18 is a graph showing a method of moving a particle by dragging the same, according to an embodiment; and

FIGS. 19 to 27 are flowcharts showing methods of manipulating a particle by using an optical tweezer, according to some embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. Expressions such as “at least one of,” when preceding a list of elements, modify the entire list of elements and do not modify the individual elements of the list.

Hereinafter, various embodiments of the disclosure are described with reference to the accompanying drawings.

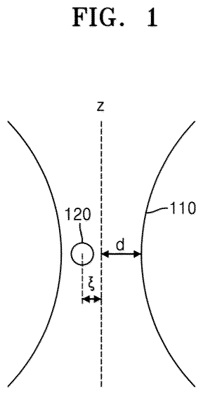

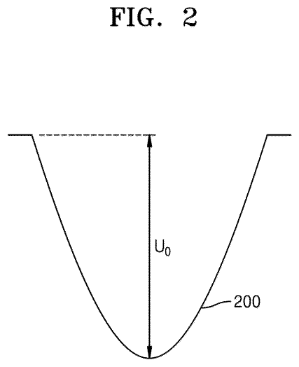

FIG. 1 is a view for explaining an optical tweezer 110 according to an embodiment. FIG. 2 is a view for explaining a potential well 200 of an optical tweezer according to an embodiment.

Referring to FIGS. 1 and 2, the optical tweezer 110 may be embodied by a focused laser beam. The intensity of a laser beam may be strongest on a central axis z of the optical tweezer 110, and may decrease in a traverse direction away from the central axis z. The intensity profile of the optical tweezer 110 may follow the intensity profile of a Gaussian beam.

The optical tweezer 110 may have a beam waist having a radial distance d that is the shortest from the central axis z. A particle 120 may be trapped in an area including the beam waist of the optical tweezer 110 and a vicinity thereof. When the radial distance d is too small, the particle 120 may be lost in a process of controlling the particle 120. When the radial distance d is too large, the optical tweezer 110 may be entangled with other particles in the process of controlling the particle 120. Accordingly, the radial distance d may have a value suitable for controlling the particle 120. For example, the radial distance d may be included in a range of about 0.1 μm to about 10 μm, but the disclosure is not limited thereto.

The optical tweezer 110 may have a potential well 200 having a depth decreasing with increasing distance from the z-axis in the traverse direction. The potential well 200 may be a harmonic potential having a depth Uₒ on the z-axis. When the depth Uₒ of the potential well 200 is too small, the particle 120 may be lost in the process of controlling the particle 120. When the depth Uₒ of the potential well 200 is too large, the optical tweezer 110 may be entangled with other particles in the process of controlling the particle 120. Accordingly, the depth Uₒ of the potential well 200 may have a value suitable for capturing the particle 120. For example, the depth Uₒ of the potential well 200 may be included in a range of about 0.1 mK to 10 mK, but the disclosure is not limited thereto.

The particle 120 may receive a force toward the z-axis by the potential well 200 of the optical tweezer 110. In a displacement ξ of the particle 120 in the traverse direction from the z-axis and the radial distance d of the optical tweezer 110, a harmonic potential U(ξ) may be expressed as in Equation 1.

$$\begin{matrix}U ( ξ ) & = \frac{{U}_{0}}{{d}^{2}} ( ξ - d ) ( d + ξ ) , & where - d \leq ξ \leq d \\ U ( ξ ) & = 0 , & otherwise\end{matrix} \qquad [ Equation 1 ]$$

The particle 120 may be a microscopic particle or an ultra-fine particle. The particle 120 may be an atom, a Rydberg atom, a neutral particle, or a dielectric particle, but the disclosure is not limited thereto. The particle 120 may include rubidium (Rb), rubidium-85 (Rb-85), rubidium-87 (Rb-87), strontium (Sr), ytterbium (Yb), cesium (Cs), or lithium (Li), but the disclosure is not limited thereto.

The optical tweezer 110 may be used to manipulate the particle 120. The optical tweezer 110 may be used to move, accelerate, or decelerate the particle 120. Furthermore, the optical tweezer 110 may be used to arrange the particle 120. Furthermore, the optical tweezer 110 may be used to arrange or rearrange an array of particles. Furthermore, the optical tweezer 110 may be used to allow the particle 120 to move through at least one other particle.

In the following description, embodiments of manipulating the particle 120 by using an optical tweezer is described in detail with reference to the accompanying drawings.

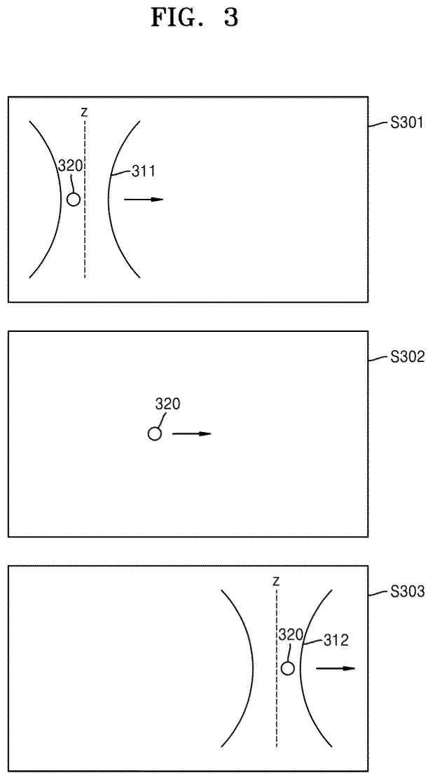

FIG. 3 is a view for explaining cases in which a particle 320 is manipulated by first and second optical tweezers 311 and 312, according to an embodiment.

A first case S301 shows a situation in which the particle 320 is accelerated by the first optical tweezer 311, a second case S302 shows a situation in which the particle 320 is freed from a trap to fly, and a third case S303 shows a situation in which the particle 320 is decelerated by the second optical tweezer 312.

Referring to the first case S301, the particle 320 may be accelerated by the first optical tweezer 311. The first optical tweezer 311 may be accelerated in a direction crossing a traveling direction of a laser beam of the first optical tweezer 311, a direction crossing the z-axis of the first optical tweezer 311, or the traverse direction of the first optical tweezer 311. The particle 320 in a state of being trapped in the first optical tweezer 311 may be accelerated by the first optical tweezer 311 that is accelerated. The particle 320 that is stopped may start to move or the velocity of the particle 320 that is moved may be increased by the first optical tweezer 311.

Referring to the second case S302, the particle 320 may freely fly without being trapped.

Referring to the third case S303, the particle 320 may be decelerated by the second optical tweezer 312. The second optical tweezer 312 may be decelerated in a direction crossing a traveling direction of a laser beam of the second optical tweezer 312, a direction crossing the z-axis of the second optical tweezer 312, or the traverse direction of the second optical tweezer 312. Alternatively, the second optical tweezer 312 may be decelerated in a flight direction of the particle 320 in the second case. The particle 320 may be trapped and decelerated by the second optical tweezer 312. The particle 320 that flies may be stopped or the velocity of the particle 320 that flies may be decelerated by the second optical tweezer 312.

The particle 320 may be thrown by the first optical tweezer 311 through the sequence of the first case S301 and the second case S302. Referring to the first and second cases S301 and S302, when the first optical tweezer 311 is turned off after the particle 320 is accelerated by accelerating the first optical tweezer 311, the particle 320 that is accelerated is no longer confined in the trap of the first optical tweezer 311 and may freely fly. Accordingly, the particle 320 may be thrown by the first optical tweezer 311.

The particle 320 may be caught by the second optical tweezer 312 through the sequence of the second case S302 and the third case S303. Referring to the second and the third cases S302 and S303, when the second optical tweezer 312 is turned on and decelerated to locate the particle 320 that flies therein, the particle 320 may be decelerated in a state of being trapped by the second optical tweezer 312. Accordingly, the particle 320 may be caught by the second optical tweezer 312.

Through the sequence of the first case S301, the second case S302, and the third case S303, the particle 320 may be thrown and caught by the first and second optical tweezers 311 and 312. Referring to the first to third cases S301, S302, and S303, the particle 320 may be thrown by accelerating and turning off the first optical tweezer 311, and the particle 320 that flies may be caught by turning off and decelerating the second optical tweezer 312.

One optical tweezer may be used to throw and catch the particle 320. In other words, the first optical tweezer 311 for throwing and the second optical tweezer 312 for catching may be the same. Alternatively, a plurality of optical tweezers may be used for throwing and catching the particle 320. In other words, the first optical tweezer 311 for throwing and the second optical tweezer 312 for catching may be separate from each other.

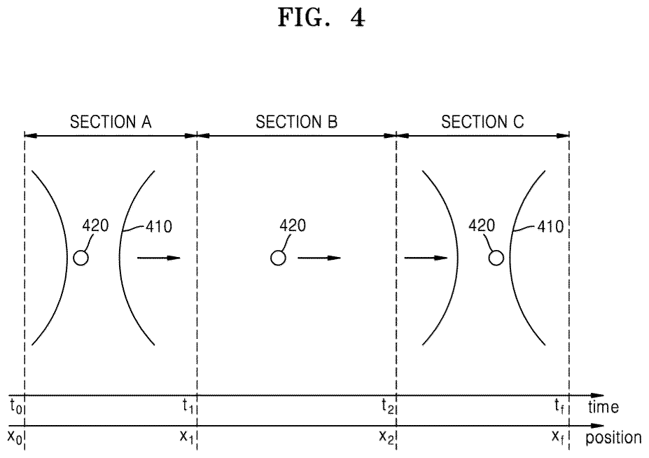

FIG. 4 is a view for explaining throwing and catching of a particle 420, by section, according to an embodiment.

In a section A, an optical tweezer 410 may be accelerated. The optical tweezer 410 that has been accelerated from t₀ to t₁ may be moved from x₀ to x₁. The position of the optical tweezer 410 may mean the position of the central axis of the optical tweezer 410. As the optical tweezer 410 is accelerated, the particle 420 trapped in the optical tweezer 410 may be accelerated.

The optical tweezer 410 may be turned off at t₁. Accordingly, the particle 420 may be freed from the trap of the optical tweezer 410. In the section A, the particle 420 may be thrown from the optical tweezer 410 based on the momentum obtained from the optical tweezer 410. As described below, as the particle 420 oscillates inside the optical tweezer 410, at t₁, the position of the particle 420 may be at x₁ or in the vicinity of x₁.

In a section B, the particle 420 may fly. From t₁ to t₂, the optical tweezer 410 may be left as being turned off. A flight time (from t₁ to t₂) and a flight distance of the particle 420 may be considered to prevent loss of the particle 420 due to spread. For example, the flight time of the particle 420 may be 18 μs or less, but the disclosure is not limited thereto. For example, the flight distance of the particle 420 may be about 200 μm or less, but the disclosure is not limited thereto.

The optical tweezer 410 may be turned on at t₂. The optical tweezer 410 may be turned on so that the particle 420 may be located therein. The position of the particle 420 may be at x₂ or around x₂ at t₂, and the optical tweezer 410 may be turned on at x₂.

In a section C, the optical tweezer 410 may be decelerated. From t₂ to t_{f}, the optical tweezer 410 that is decelerated may be moved from x₂ to x_{f}. The particle 420 trapped in the optical tweezer 410 that is turned on may be decelerated as the optical tweezer 410 decelerates. Accordingly, the particle 420 that flies may be caught by the optical tweezer 410.

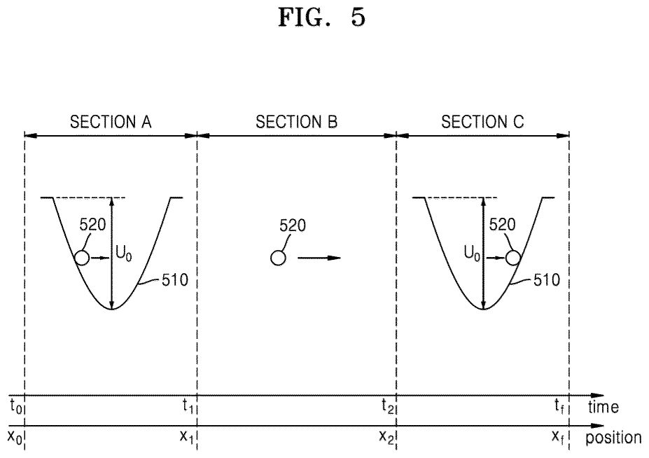

FIG. 5 is a view for explaining a potential well 510 of an optical tweezer, section by section, according to an embodiment.

The descriptions with reference to FIG. 4 may be applied to the embodiment with reference to FIG. 5, and a portion that is not described in FIG. 4 is described with reference to FIG. 5.

In the section A, the depth of the potential well 510 of an optical tweezer may be U₀. A particle 520 may be in a state of being trapped in the potential well 510 of the optical tweezer.

At t₁, the depth of the potential well 510 of the optical tweezer may be reduced to 0. As the optical tweezer is turned off, the depth of the potential well 510 of the optical tweezer may be 0.

In the section B, the depth of the potential well 510 of the optical tweezer may remain in 0. The particle 520 that is not trapped in the potential well 510 may freely fly.

At t₂, the depth of the potential well 510 of the optical tweezer may be increased to U₀. As the optical tweezer is turned on, the depth of the potential well 510 of the optical tweezer may be U₀.

In the section C, the depth of the potential well 510 of the optical tweezer may be U₀. The particle 520 may be trapped again in the potential well 510 of the optical tweezer.

Although an embodiment in which the depth of the potential well 510 is the same in the sections A and C, is described above, in another embodiment, the depth of the potential well 510 may be different from each other in the sections A and C. For example, in the section A, the depth of the potential well 510 may be U₁, and in the section C, the depth of the potential well 510 may be U₂, and the depths U₁ and U₂ may be different from each other.

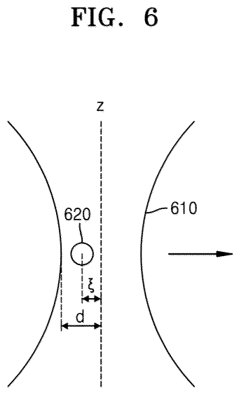

FIG. 6 is a view for explaining the maximum acceleration of an optical tweezer 610, according to an embodiment.

In the optical tweezer 610 that is accelerated, a displacement ξ(t) of a particle 620 with respect to a position x of the optical tweezer 610 may be expressed as in Equation 2. The position x of the optical tweezer 610 may mean that the position of the optical tweezer 610 on the central axis z.

$$ξ ( t ) = - \frac{\ddot{x}}{{ω}^{2}} + A cos ( ω t + ϕ ) \qquad [ Equation 2 ]$$

In Equation 2, ω denotes a trap frequency, and A denotes an oscillation amplitude.

The trap frequency ω may be expressed as in Equation 3.

ω=\sqrt{2U₀/md²} [Equation 3]

In Equation 3, U₀ denotes a depth of a potential well of the optical tweezer 610, m denotes a mass of the particle 620, and d denotes a radial distance of the optical tweezer 610.

The oscillation amplitude A may be expressed as in Equation 4.

A=\sqrt{(ξ₀−\ddot{x}/ω²)²+(\dot{ξ}₀/ω)²} [Equation 4]

In Equation 4, ξ₀ denotes an initial displacement, and \dot{ξ}₀ denotes an initial velocity.

Due to an inertia force by the optical tweezer 610 that is accelerated, the particle 620 may oscillates in a state of being lagged by

$$- \frac{\ddot{x}}{{ω}^{2}}$$

from Equation 2 in a direction opposite to the acceleration direction of the optical tweezer 610 on the central axis z based on the center of a trap.

To prevent the particle 620 from escaping from the optical tweezer 610 that is accelerated, the maximum magnitude of the displacement ξ(t) of the particle 620 may be less than or equal to the radial distance d of the optical tweezer 610. Referring to Equations 2 to 4, the displacement ξ(t) of the particle 620 is a function for an acceleration \ddot{x} of the optical tweezer 610. When the initial displacement and initial velocity of the particle 620 is 0, a maximum acceleration aₘₐₓ of the optical tweezer 610 to prevent the particle 620 from escaping from the optical tweezer 610 that is accelerated may be expressed as in Equation 5.

$${a}_{max} = \frac{{U}_{0}}{md} \qquad [ Equation 5 ]$$

It is produced from Equation 5 that the magnitude of acceleration of the optical tweezer 610 to prevent the particle 620 from escaping from the optical tweezer 610 that is accelerated is less than or equal to a value obtained by dividing the depth U₀ of a potential well of the optical tweezer 610 by a product of the radial distance d of the optical tweezer 610 and the mass of the particle 620.

To manipulate the particle 620 using the optical tweezer 610, the depth U₀ of a potential well in a range of about 0.1 mK to about 10 mK and the radial distance d in a range of about 0.1 μm to about 10 μm may be considered. Furthermore, an average atomic mass of Rb of 85.4678 u, an atomic mass of Sr of 87.62 u, an atomic mass of Yb of 173.04 u, an atomic mass of Cs of 132.90545 u, and an atomic mass of Li of 6.941 u may be considered as the mass m of the particle 620. A range of about 4.80*10² m/s^{b 2} to about 1.20*10⁶ m/s² may be produced therefrom as a range of the maximum acceleration aₘₐₓ of the optical tweezer 610 to successfully manipulate the particle 620.

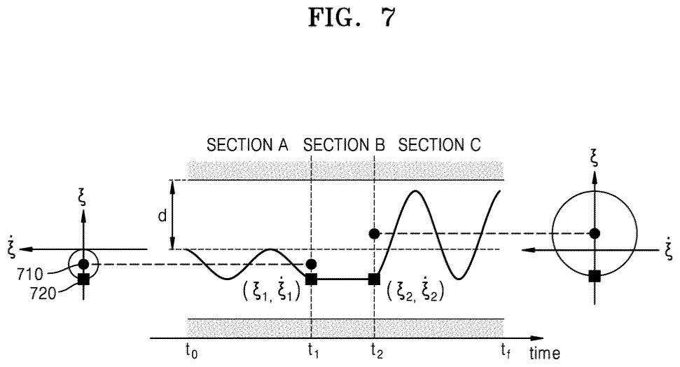

FIG. 7 is a view for explaining a movement of a particle, according to an embodiment.

In FIG. 7, a black circular point denote an oscillation center 710 of an optical tweezer, and a black square point denotes a particle 720. In an embodiment, the optical tweezer is accelerated in the section A, and decelerated in the section C. Furthermore, the optical tweezer is left as being turned on in the sections A and C, and as being turned off in the section B. Furthermore, the depth of a potential well of the optical tweezer is Uₒ in the sections A and C, and 0 in the section B. Furthermore, the particle 720 is accelerated in the section A, is thrown at a boundary between the section A and the section B, flies in the section B, is caught at a boundary between the section B and the section C, and is decelerated in the section C.

In the section A, due to the lagging by the inertia force, the oscillation center 710 may be located behind the central axis of the optical tweezer. The particle 720 may be accelerated by oscillating around the oscillation center 710. When the initial displacement and initial velocity of the particle 720 are 0 and the acceleration of the optical tweezer is a, in the section A, the displacement ξ(t) of the particle 720 may be expressed as in Equation 6.

$$\begin{matrix}ξ ( t ) = - \frac{a}{{ω}^{2}} + {A}_{1} cos ( ω t ) & for\end{matrix} {t}_{0} < t < {t}_{1} \qquad [ Equation 6 ]$$

In Equation 6, a₁ denotes an oscillation amplitude. The oscillation amplitude al may be expressed as in Equation 7.

A₁=a/ω² [Equation 7]

It is produced from Equations 6 and 7 that, in the section A, the maximum magnitude of the displacement of the particle 720 is 2a/ω². In the section A, to prevent the particle 720 from escaping from the optical tweezer, as the maximum magnitude, i.e., 2a/ω², of the displacement of the particle 720 is less than or equal to the radial length d of the optical tweezer,

$$\frac{2 a}{{ω}^{2}} \leq d$$

is satisfied. An acceleration condition of the optical tweezer to successfully throw the particle 720 is generated therefrom. By solving the acceleration condition,

$$a \leq \frac{{U}_{0}}{md}$$

is produced. Ihis matches the maximum acceleration of Equation 5.

In the section B, the particle 720 that is not trapped by the optical tweezer may fly. In the section B, the displacement ξ(t) of the particle 720 may be expressed as in Equation 8.

ξ(t)=ξ₁+\dot{ξ}₁(t−t₁) for t₁<t<t₂ [Equation 8]

In Equation 8, ξ₁ denotes a displacement of the particle 720 at t₁, and \dot{ξ}₁ denotes a velocity of the particle 720 at t₁. ξ₁ and \dot{ξ}₁ may be expressed as in Equations 9 and 10, respectively.

$${ξ}_{1} = \frac{a}{{ω}^{2}} ( cos {θ}_{1} - 1 ) \qquad [ Equation 9 ]$$

$${\dot{ξ}}_{1} = - \frac{a}{ω} sin {θ}_{1} \qquad [ Equation 10 ]$$

In Equations 9 and 10, θ₁=ωt₁.

In the section C, due to the inertia force of the particle 720 that flies, the oscillation center 710 may be located in front of the central axis of the optical tweezer. The particle 720 may be decelerated by oscillating around the oscillation center 710. When the acceleration of the optical tweezer that is decelerated is −a, in the section C, the displacement ξ(t) of the particle 720 may be expressed as in Equation 11.

$$\begin{matrix}( t ) = \frac{a}{{ω}^{2}} + {A}_{2} cos ( ω ( t - {t}_{2} ) + {θ}_{2} ) & for {t}_{2} < t < {t}_{f}\end{matrix} \qquad [ Equation 11 ]$$

In Equation 11,a₂ denotes an oscillation amplitude, and

$${θ}_{2} = {sin}^{- 1} ( \frac{a}{{ω}^{2} {A}_{2}} sin {θ}_{1} ) .$$

The oscillation amplitude a₂ may be expressed as in Equation 12.

A₂=\sqrt{(ξ₂=a/ω)²+(\dot{ξ}₂/ω)²} [Equation 12]

In Equation 12, ξ₂ denotes the displacement of the particle 720 at t₂, and \dot{ξ}₂ denotes the velocity of the particle 720 at t₂. ξ₂ and \dot{ξ}₂ may be expressed as in Equations 13 and 14, respectively.

$${ξ}_{2} = \frac{a}{{ω}^{2}} + {A}_{2} cos {θ}_{2} \qquad [ Equation 13 ]$$

$${\dot{ξ}}_{2} = - \frac{a}{ω} sin {θ}_{1} \qquad [ Equation 14 ]$$

In order to trap the particle 720 that flies, the displacement of the particle 720 at t₂ is less than or equal to the radial length d of the optical tweezer. Furthermore, in the section C, to prevent the particle 720 from escaping from the optical tweezer, the maximum magnitude of the displacement of the particle 720 is less than the radial length d of the optical tweezer. The displacement,

$$\frac{a}{{ω}^{2}} + {A}_{2} cos {θ}_{2} ,$$

of the particle 720 at t₂ is provided from Equation 13, and in the section C, the maximum magnitude,

$$\frac{a}{{ω}^{2}} + {A}_{2} ,$$

displacement of the particle 720 is provided from Equation 11. The acceleration condition of the optical tweezer to successfully catch the particle 720 is generated therefrom.

FIG. 7 illustrates the velocity-displacement of the particle 720 when the particle 720 is thrown when θ₁=3π. When θ₁=3π, the relative velocity of the particle 720 to the optical tweezer may be 0. Accordingly, when the particle 720 is moved at a constant speed in the section B and the optical tweezer is turned on at t₂, it may be that ξ₁=ξ₂.

The velocity-displacement of the particle 720 is not limited to the illustration of FIG. 7. This is because the particle 720 may have various velocities and displacements depending on the time when the optical tweezer is turned off. For example, when the particle 720 is thrown at a time when θ₁=2π, the relative velocity and displacement of the particle 720 to the optical tweezer may be 0. Accordingly, it may be that ξ₁=ξ₂=0. For example, when the particle 720 is thrown at a time when θ₁=1.5π, the relative velocity of the particle 720 to the optical tweezer may be a positive number. Accordingly, it may be that ξ₁>ξ₂. For example, when the particle 720 is thrown at a time when θ₁=2.5π, the relative velocity of the particle 720 to the optical tweezer may be a negative number. Accordingly, it may be that ξ₁>ξ₂.

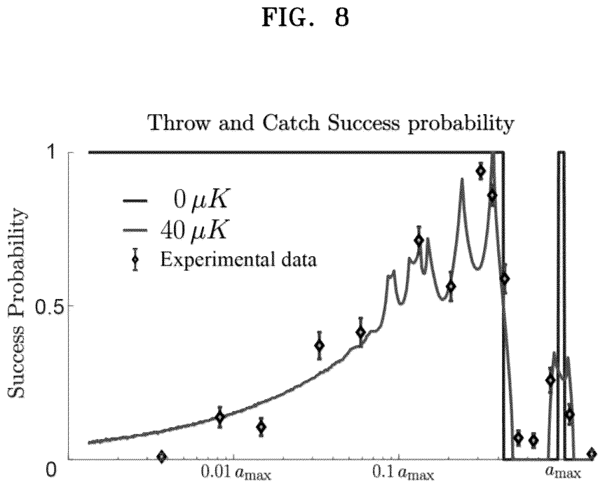

FIG. 8 is a success probability graph of throwing and catching of a particle, according to an embodiment.

In a 40 uK temperature environment, an experiment in which a particle is thrown and caught by an optical tweezer was performed. In the experiment, the optical tweezer was accelerated and decelerated with various accelerations. In the experiment, an Rb atom (Rb-87) was used as a particle. Furthermore, the depth U₀ of a potential well of the optical tweezer used in the experiment was 1.94(15) mK or 0.76(6) mK, and the radial length d of the optical tweezer was 0.7 μm. Furthermore, the acceleration of the same magnitude was used for the acceleration and deceleration of the optical tweezer.

Referring to the graph, when

$${a}_{max} = \frac{{U}_{0}}{md} ,$$

it was observed that a success probability increased to about 0.25aₘₐₓ, decreased at about 0.4aₘₐₓ, increased again to about 0.6aₘₐₓ, and decreased after about aₘₐₓ. Furthermore, a maximum success probability of 94(3)% was observed.

It may be interpreted from the acceleration condition of the optical tweezer to successfully throw the particle described with reference to FIGS. 6 and 7 that the success probability decreases after about aₘₐₓ. Furthermore, it may be interpreted from the acceleration condition of the optical tweezer to successfully catch the particle described with reference to FIG. 7 that the success probability decreases at about 0.4aₘₐₓ.

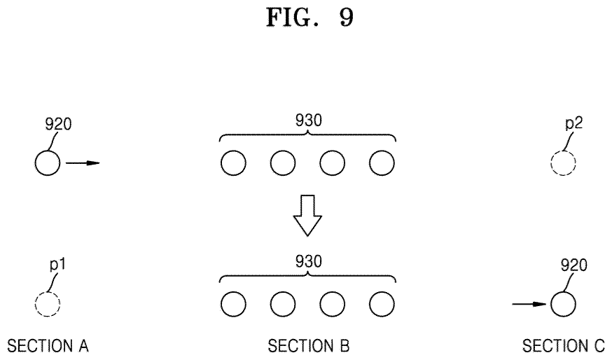

FIG. 9 is a view for explaining a particle 920 moving through at least one other particle 930, according to an embodiment.

When moving the particle 920 from a position p1 to a position p2, the at least one other particle 930 may be located between the position p1 and the position p2. The at least one other particle 930 may be the same as or different from the type of the particle 920. The at least one other particle 930 may be trapped by other optical tweezer. The at least one other particle 930 may include a plurality of particles arranged in line. The particles may have the same or different types. The number of the particles may be two or more, but the disclosure is not limited to the number of those illustrated in FIG. 9.

The particle 920 may be thrown and caught by the optical tweezer and moved from the position p1 to the position p2. The particle 920 may be accelerated and thrown in the section A, may fly in the section B, and may be caught and decelerated in the section C.

In the section B, as the optical tweezer of the particle 920 is left as being turned off, an interaction may not be generated between the optical tweezer of the particle 920 and the at least one other particle 930. Furthermore, the interaction may not be generated between the optical tweezer of the particle 920 and other optical tweezer of the at least one other particle 930. Accordingly, even when the at least one other particle 930 exists in the path of the particle 920, without bypassing or removing the at least one other particle 930, the particle 920 may move through the at least one other particle 930. Accordingly, efficient arrangement and rearrangement of a particle array may be provided.

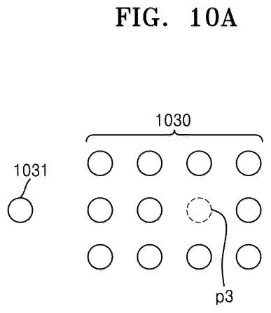

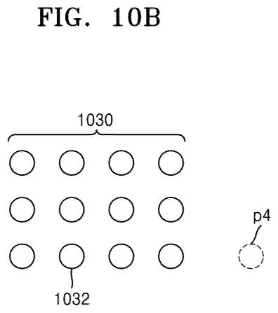

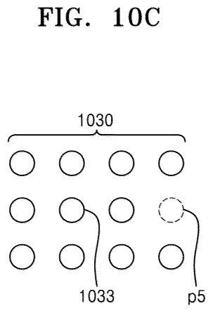

FIGS. 10A to 10C are views for explaining the rearrangement of a particle array 1030, according to some embodiments.

The particle array 1030 may include particles that are arbitrarily arranged. The particles included in the particle array 1030 may have the same or different types. The number of the particles included in the particle array 1030 may be two or more, and the disclosure is not limited to the number of those illustrated in FIGS. 10A to 10C. The particle array 1030 may be a two-dimensional array or three-dimensional array, and the disclosure is not limited to the structure illustrated in FIGS. 10A to 10C.

Referring to FIG. 10A, for the rearrangement of the particle array 1030, a particle 1031 may be moved to a position p3. For example, to reinforce a particle lost in the particle array 1030, the particle 1031 may be moved from the outside to the inside of the particle array 1030.

Referring to FIG. 10B, for the rearrangement of the particle array 1030, a particle 1032 may be moved to a position p4. For example, to remove the particle 1032 from the particle array 1030, the particle 1032 may be moved from the inside to the outside of the particle array 1030.

Referring to FIG. 10C, for the rearrangement of the particle array 1030, a particle 1033 may be moved to a position p5. For example, to change the structure of the particle array 1030, the particle 1033 may be moved inside the particle array 1030.

In FIGS. 10A to 10C, for the rearrangement of the particle array 1030, the particles 1031 to 1033 may be thrown or caught by the optical tweezer. Likewise the description with reference to FIG. 9, in a process of moving the particles 1031 to 1033, the interaction between the optical tweezer and the particle array 1030 may not be generated. Accordingly, for the rearrangement of the particle array 1030, the manipulation of other particles of the particle array 1030 may be unnecessary. Accordingly, an efficient rearrangement of the particle array 1030 may be provided.

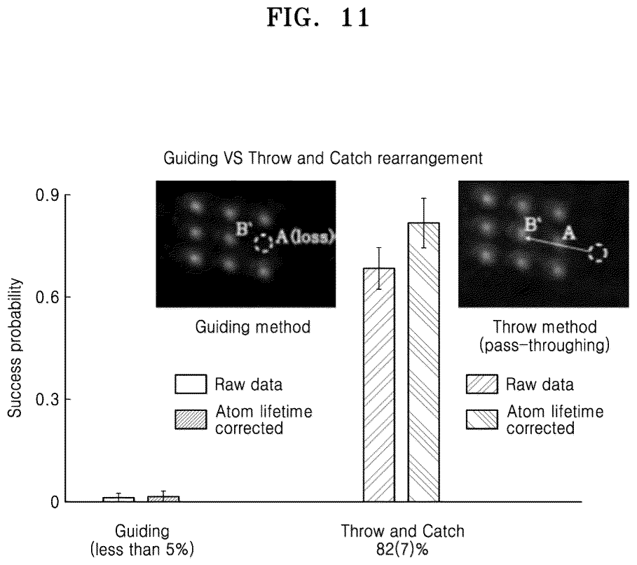

FIG. 11 is a success probability graph of the rearrangement of a particle array, according to an embodiment.

An experiment of arranging a particle B from the outside to the inside of a particle array was performed. In the experiment, a particle A is located in the path of a particle B. To move the particle B, a method of throwing and catching the particle B using an optical tweezer (Throw and Catch) was used. As a comparative group, a method of moving an optical tweezer in a state of trapping the particle B using the optical tweezer (Guiding) was used.

Referring to the graph, in the related-art method (Guiding), the rearrangement probability of the particle B is less than 5%, whereas in the throwing and catching method (Throw and Catch), the rearrangement probability of the particle B is 82(7)%. It may be checked from the above that the rearrangement of a particle array may be successfully performed through the throwing and catching method (Throw and Catch).

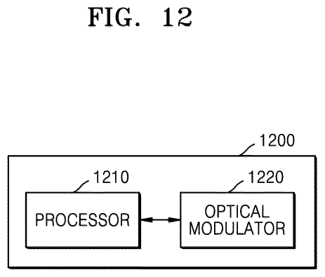

FIG. 12 is a block diagram of a system 1200 according to an embodiment.

The system 1200 may include a processor 1210 and an optical modulator 1220. FIG. 12 illustrates constituent elements of the system 1200 for explaining the disclosure, and the system 1200 may further include other constituent elements that are not illustrated in FIG. 12. For example, the system 1200 may further include a memory or a camera.

The processor 1210 may control the overall operation of the system 1200. The processor 1210 may control the optical modulator 1220 to manipulate a particle by using an optical tweezer. The processor 1210 may be a central processing unit (CPU), a graphics processing unit (GPU), a neural processing unit (NPU), or each core of a multi-core processor, but the disclosure is not limited thereto. The processor 1210 may be mounted in an electronic apparatus. The electronic apparatus may include a personal computer (PC), a laptop computer, a smart phone, a tablet computer, or a classical computer, but the disclosure is not limited thereto.

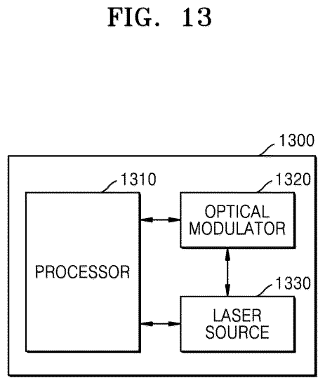

The optical modulator 1220 may control an optical tweezer by interfering a laser beam with a pulse. To manipulate a particle, the optical modulator 1220 may control an optical tweezer in response to a control signal of the processor 1210. The optical modulator 1220 may include at least one of an absorptive modulator or a refractive modulator. The optical modulator 1220 may include at least one of an acousto-optic deflector (AOD), a spatial light modulator (SLM), an electro-optic modulator, or micromechanical modulator. The optical modulator 1220 may include at least one of a 2D AOD or a 3D AOD. The optical modulator 1220 is not limited to the listed types. FIG. 13 is a block diagram of a system 1300 according to an embodiment.

The system 1300 may include a processor 1310, an optical modulator 1320, and a laser source 1330. The descriptions presented with reference to FIG. 12 may be applied to the system 1300.

The processor 1310 may control the optical modulator 1320 and the laser source 1330 to manipulate a particle by using an optical tweezer. The optical modulator 1320 may control the optical tweezer by interfering a laser beam output form the laser source 1330 with a pulse. The optical modulator 1320 may control the direction and intensity of the laser beam output form the laser source 1330 in response to a control signal of the processor 1310. The laser source 1330 may output a laser beam, stop the output of the laser beam, or resume the output of the laser beam, in response to the control signal of the processor 1310.

The laser source 1330 may be a device for emitting coherent light. The laser source 1330 may include at least one of an infrared laser, an ultraviolet laser, an X-ray laser, or a gamma-ray laser. The laser source 1330 may include at least one of a gas laser, a solid-state laser, a fiber laser, a liquid laser, a dye laser, a semiconductor laser, or a laser diode. The laser source 1330 is not limited the listed types.

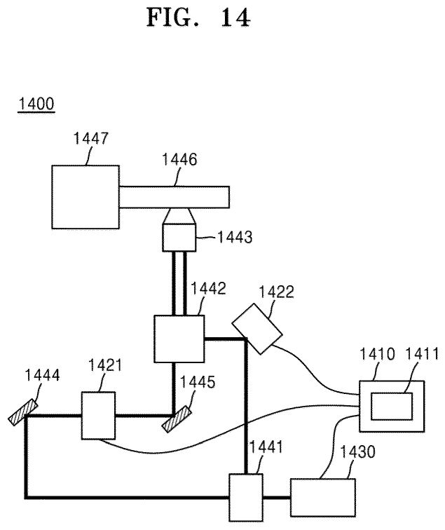

FIG. 14 is a block diagram of a system 1400 according to an embodiment.

The system 1400 may include an electronic apparatus 1410, a processor 1411, first and second optical modulators 1421 and 1422, a laser source 1430, first and second beam splitters 1441 and 1442, an objective lens 1443, mirrors 1444 and 1445, a glass cell 1446, and a vacuum chamber 1447. The descriptions presented with reference to FIGS. 12 and 13 may be applied to the system 1400.

A laser beam output from the laser source 1430 may be split by the first beam splitter 1441. The split laser beam may be modulated by the first and second optical modulators 1421 and 1422. The modulated laser beam may be transmitted and reflected by the second beam splitter 1442. The first and second beam splitters 1441 and 1442 may include a polarizing beam splitter (PBS), but the disclosure is not limited thereto. The transmitted and reflected laser beams may be focused by the objective lens 1443. The focused laser beam may implement an optical tweezer in the vacuum chamber 1447.

The vacuum chamber 1447 may include an ultra-high vacuum (UHV) chamber. The vacuum chamber 1447 may have a pressure environment suitable for manipulating a particle by using an optical tweezer. A suitable pressure environment may mean an environment in which a particle is not disturbed by other particles. The pressure environment of the vacuum chamber 1447 may be about 1×10⁻¹¹ torr or less, but the disclosure is not limited thereto.

At least one particle and at least one optical tweezer may be arranged in the vacuum chamber 1447. Furthermore, a particle array and a plurality of optical tweezers may be arranged in the vacuum chamber 1447. The optical tweezers may include an optical tweezer for a fixed particle and an optical tweezer for a moving particle.

In an embodiment, the optical tweezer for a moving particle may be controlled by the first optical modulator 1421. The optical tweezer for a fixed particle may be controlled by the second optical modulator 1422. The first optical modulator 1421 may include an optical modulator with performance to move the optical tweezer at a desirable velocity. For example, the first optical modulator 1421 may include an AOD, but the disclosure is not limited thereto. The second optical modulator 1422 may include an optical modulator with high resolution to fix many particles in a narrow area. For example, the second optical modulator 1422 may include an SLM, but the disclosure is not limited thereto.

In an embodiment, a fixed particle in a particle array may be trapped by an optical tweezer of the second optical modulator 1422. A particle in the particle array for rearrangement may be manipulated by the first optical modulator 1421. The particle may be rearranged by being thrown and caught by the first optical modulator 1421.

In an embodiment, a particle may be thrown and caught by the first optical modulator 1421.

In an embodiment, a particle may be thrown by the first optical modulator 1421 and caught by the second optical modulator 1422. In this case, the first and second optical modulators 1421 and 1422 may include optical modulator with performance to move an optical tweezer at a desirable velocity.

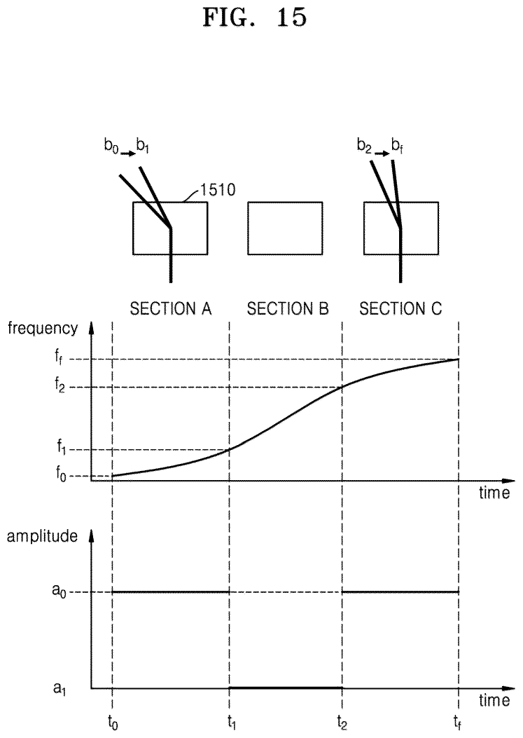

FIG. 15 is a graph showing the control of an optical modulator, according to an embodiment.

To manipulate a particle by using an optical tweezer, a processor may control an optical modulator. The optical modulator may accelerate, move, and decelerate the optical tweezer in response to a control signal of the processor. Furthermore, the optical modulator may turn on or off the optical tweezer in response to a control signal of the processor.

The optical modulator may control the optical tweezer by interfering a pulse propagated through a medium 1510 with a laser beam. The pulse may include a frequency in a radio frequency (RF) band.

The optical modulator may operate under a Bragg condition. The frequency of the pulse of the optical modulator may determine an output direction of a diffracted laser beam. As the frequency of the pulse of the optical modulator increases, the output traveling direction of the laser beam may rotate in one direction. As an increment of the frequency of the pulse of the optical modulator increases, the output traveling direction of the laser beam may rotate fast in one direction. As the frequency of the pulse of the optical modulator decreases, the output traveling direction of the laser beam may rotate in the opposite direction.

FIG. 15 illustrates a frequency graph and an amplitude graph of the frequency of the pulse of the optical modulator, according to an embodiment. Furthermore, FIG. 15 illustrates a laser beam passing through the medium 1510 of the optical modulator, according to an embodiment. Referring to FIG. 15, in the section A, the optical modulator may increase an increment of the frequency of a pulse. In detail, from t₀ to t₁, the optical modulator may increases Δf/Δt and also increase the frequency of the pulse from f₀ to f₁. Accordingly, the output traveling direction of the laser beam may be gradually quickly changed from b₀ to b₁. Accordingly, the optical tweezer may be accelerated, and a particle may be accelerated by the optical tweezer that is accelerated.

At t₁, the optical modulator may reduce the amplitude of a pulse from a₀ to a₁. In detail, the optical modulator may reduce the amplitude of a pulse to 0. Accordingly, when the optical tweezer is turned off, a particle may be thrown by the optical tweezer that is turned off.

In the section B, the optical modulator may maintain the amplitude of a pulse to 0. Accordingly, the particle may fly without being trapped by the optical tweezer.

In the section B, the optical modulator may increase the frequency of the pulse. In detail, from t₁ to t₂, the optical modulator may increase the frequency of the pulse at a constant Δf/Δt from f₁ to f₂. As the optical tweezer is turned off in the section B, between t₁ and t₂, it may not be essential to consider the position of the optical tweezer. Accordingly, unlike the illustration of FIG. 15, in t₁ and t₂, the optical modulator may set the frequency of the pulse to a certain frequency.

At t₂, the optical modulator may increase the amplitude of a pulse from the amplitude ai to the amplitude av. Furthermore, at t₂, the frequency of the pulse may be f₂, and the output traveling direction of the laser beam may be b₂. Accordingly, the optical tweezer may be turned on at a position where the particle that flies is located inside, and the particle that flies may be caught by the optical tweezer that is turned on.

In the section C, the optical modulator may reduce an increment of the frequency of a pulse. In detail, from t₂ to t_{f}, the optical modulator may reduce the ratio Δf/Δt and also increase the frequency of the pulse from f₂ to f_{f}. Accordingly, the output traveling direction of the laser beam may be slowly changed from b₂ to b_{f}. Accordingly, the optical tweezer may be decelerated, and the particle may be decelerated by the optical tweezer that is decelerated.

Although an embodiment in which the amplitude of the pulse of the optical modulator is the same in the sections A and C is described above, in another embodiment, the amplitude of the pulse of the optical modulator may be different from each other in the sections A and C. For example, the amplitude of the pulse of the optical modulator in the section A may be a₂, the amplitude of the pulse of the optical modulator in the section C may be a₃, and a₂ and a₃ may be different from each other.

The processor may control the output of a laser source, instead of controlling the amplitude of the pulse of the optical modulator in the section B. In detail, the processor may stop the output of the laser source at t₁ and resume the output of the laser source at t₂.

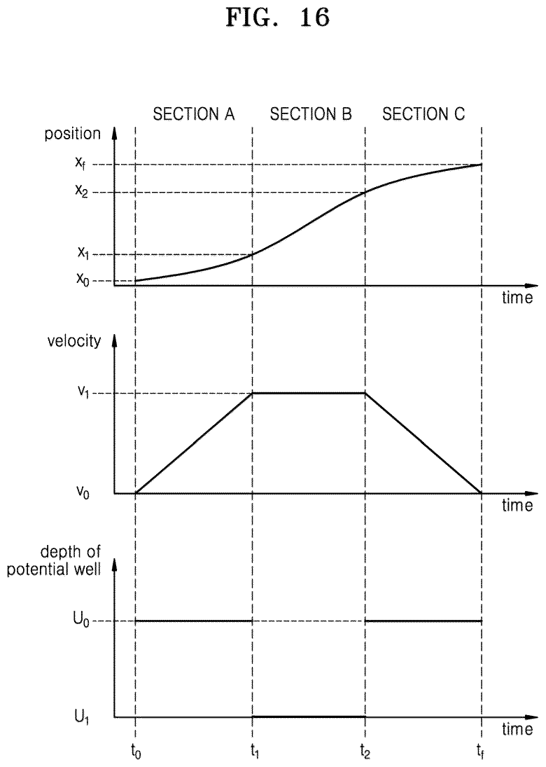

FIG. 16 is a graph showing the movement of an optical tweezer, according to an embodiment.

FIG. 16 shows the movement of an optical tweezer based on the control of an optical modulator according to the embodiment of FIG. 15.

In the section A, as the increment of the frequency of the pulse of the optical modulator increases, the velocity of the optical tweezer may be increased from v₀ to v₁. Furthermore, as the amplitude of the pulse of the optical modulator is maintained constant, the depth of a potential well of the optical tweezer may be maintained to be U₀.

As the amplitude of the pulse of the optical modulator decreases at t₁, the depth of the potential well of the optical tweezer may be reduced. In detail, as the amplitude of the pulse of the optical modulator is 0, the depth of the potential well of the optical tweezer may be 0.

In the section B, as the increment of the frequency of the pulse of the optical modulator is constant, the velocity of the optical tweezer may be maintained to be v₁. As the depth of the potential well of the optical tweezer is 0, the optical tweezer is in a turn-off state. However, as the frequency of the pulse of the optical modulator is being controlled, the position of the optical tweezer that is turned off may be moved from x₁ to x₂.

As the amplitude of the pulse of the optical modulator is increased at t₂, the depth of the potential well of the optical tweezer may be increased.

As the increment of the frequency of the pulse of the optical modulator decreases in the section C, the velocity of the optical tweezer may be reduced from v₀ to v₁. Furthermore, as the amplitude of the pulse of the optical modulator is maintained constant, the depth of the potential well of the optical tweezer may be maintained to be U₀.

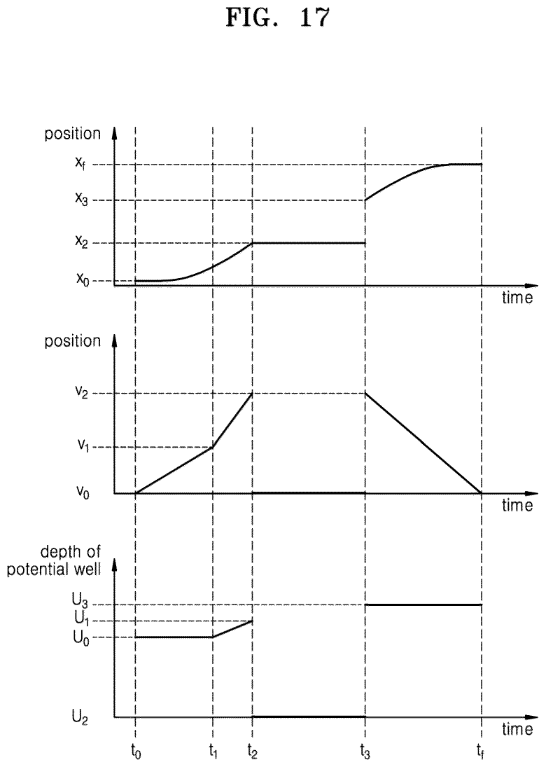

FIG. 17 is a graph showing the movement of an optical tweezer according to an embodiment.

To throw and catch a particle, various scenarios to accelerate and decelerate the optical tweezer and various scenarios to adjust the depth of the potential well of the optical tweezer may be used. FIG. 17 shows an embodiment of controlling the optical tweezer according to a different scenario from those of FIGS. 15 and 16.

From t₀ to t₁, the velocity of the optical tweezer may be increased from v₀ to v₁. To this end, the increment of the frequency of the pulse of the optical modulator may be increased. A particle may be accelerated by the optical tweezer that is accelerated.

From t₁ to t₂, the velocity of the optical tweezer may be increased from v₁ to v₂ at a faster acceleration than that in t₀ to t₁. To this end, the frequency of the pulse of the optical modulator may be increased at an increment greater than that in t₀ to t₁. The particle may be accelerated at an acceleration greater than that in t₀ to t₁. In order not to lose the particle that is accelerated, the depth of the potential well of the optical tweezer may be increased from U₀ to U₁. Alternatively, unlike the illustration of FIG. 17, the depth of the potential well of the optical tweezer may be maintained constant at U₁.

At t₂, the optical tweezer may be turned off. To this end, the amplitude of the pulse of the optical modulator may be reduced to 0. Accordingly, the particle may be thrown by the optical tweezer.

From t₂ to t₃, the velocity of the optical tweezer may be maintained to be vo. In detail, the velocity of the optical tweezer may be maintained to 0. To this end, the frequency of the pulse of the optical modulator may be maintained constant. As the velocity of the optical tweezer is 0, the optical tweezer may stay at x₂.

At t₃, the optical tweezer may be turned on. To this end, the amplitude of the pulse of the optical modulator may be increased. At t₃, the position of the optical tweezer may be x₃. To this end, the frequency of the pulse of the optical modulator at t₃ may be greater than the frequency of the pulse of the optical modulator at t₂. The particle may be located inside the optical tweezer that is turned on.

From t₃ to t_{f}, the velocity of the optical tweezer may be decreased from v₂to v₀. To this end, the increment of the frequency of the pulse of the optical modulator may be reduced. The particle may be decelerated by the optical tweezer that is decelerated. The depth of the potential well of the optical tweezer may be maintained to be U₃. The depth U₃ of the potential well of the optical tweezer from ts to t₁ may be greater than the depths U₀ and U₁ of the potential well of the optical tweezer from t₀ to t₂. Alternatively, unlike the illustration of FIG. 17, U₃ may be less than U₀ and U₁ or between U₀ and U₁.

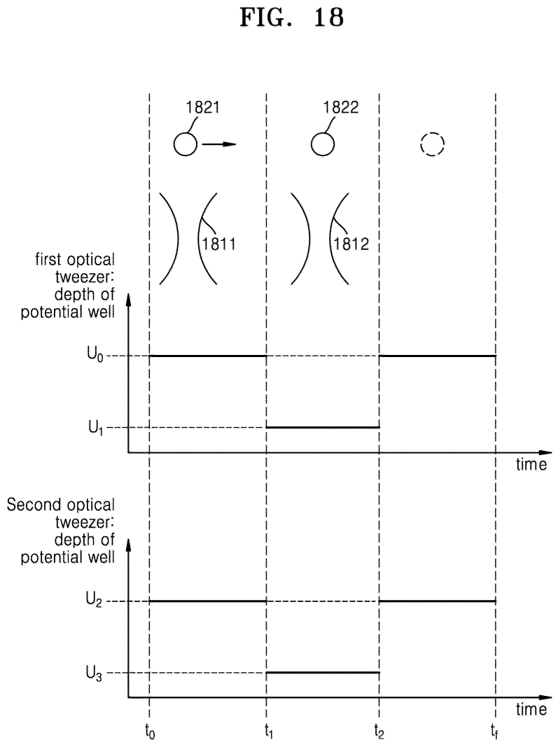

FIG. 18 is a graph showing a method of moving a particle 1821 by dragging the same, according to an embodiment.

In order to successfully move the particle 1821 through another particle 1822, an interaction between a first optical tweezer 1811 and a second optical tweezer 1812 needs to be reduced. To this end, a method of reducing the depths of potential wells of the first optical tweezer 1811 and the second optical tweezer 1812 while the particle 1821 moves through the other particle 1822 may be considered.

From t₀ to t₁, the particle 1821 may be dragged by the first optical tweezer 1811 to approach the other particle 1822.

At t₁, the depth of the potential well of the first optical tweezer 1811 may be reduced from U₀ to U₁. Furthermore, the depth of the potential well of the second optical tweezer 1812 may be reduced from U₂ to U₃.

From t₁ to t₂, the particle 1821 may move through the other particle 1822. While the particle 1821 moves through the other particle 1822, the depth of the potential well of the first optical tweezer 1811 may be maintained to be U₁. U₁ may not be 0. U₁ may be greater than the minimum value at which the first optical tweezer 1811 drags the particle 1821 without losing. Furthermore, U₁ may be less than the maximum value at which the first optical tweezer 1811 prevents the other particle 1822 from escaping from the second optical tweezer 1812. The depth of the potential well of the second optical tweezer 1812 may be maintained to be U₃. U₃ may not be 0. U₃ may be greater than the minimum value at which the second optical tweezer 1812 prevents the other particle 1822 from losing. Furthermore, U₃ may be less than the maximum value at which the second optical tweezer 1812 prevents the particle 1821 from escaping from the first optical tweezer 1811.

From t₂ to t_{f}, the particle 1821 may be dragged by the first optical tweezer 1811 to be away from the other particle 1822.

While the particle 1821 moves through the other particle 1822, by lowering the depths of the potential wells of the first and second optical tweezers 1811 and 1812, a probability of losing the other particle 1822 by the first optical tweezer 1811 and a probability of losing the particle 1821 by the second optical tweezer 1812 may be reduced.

In the following description, a method of manipulating a particle by using an optical tweezer according to some embodiments is described with reference to flowcharts. Although omitted in the following description, the descriptions presented above with reference to FIGS. 1 to 18 may be applied to the method described below. Furthermore, although not mentioned below, the following method may be performed by the system of FIGS. 12 to 14.

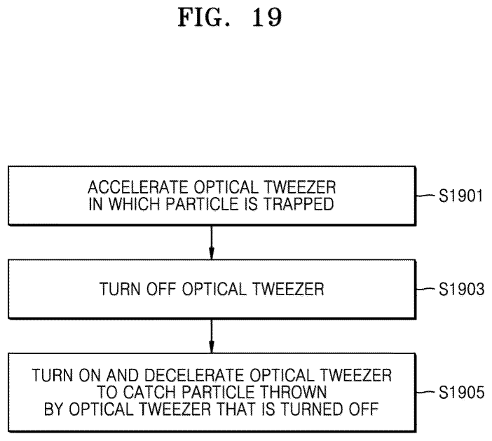

FIG. 19 is a flowchart showing a method of manipulating a particle by using an optical tweezer, according to an embodiment.

In operation S1901, an optical tweezer in which a particle is trapped may be accelerated. The optical tweezer may be accelerated in a direction crossing a traveling direction of a laser beam of the optical tweezer, a direction crossing the z axis of the optical tweezer, or a traverse direction of the optical tweezer. The acceleration of the optical tweezer may be within an acceleration range for successfully throwing a particle without losing the particle. The maximum value of the magnitude of acceleration of the optical tweezer may be a value obtained by dividing the depth of the potential well of the optical tweezer by a product of a radial distance of the optical tweezer and the mass of the particle.

In operation S1903, the optical tweezer may be turned off. The optical tweezer may be turned off by reducing the magnitude of a pulse of the optical modulator to 0. Alternatively, the optical tweezer may be turned off by stopping the output of a laser source. As the optical tweezer is turned off, the particle may be thrown by the optical tweezer.

In operation S1905, to catch the particle thrown by the optical tweezer that is turned off, the optical tweezer may be turned on and decelerated. The optical tweezer may be turned on by increasing the magnitude of the pulse of the optical modulator. Alternatively, the optical tweezer may be turned on by resuming the output of the laser source. To prevent the particle from being lost by diffusion, the optical tweezer may be turned on within about 18 us or less after the throwing of the particle. Furthermore, to prevent the particle from being lost by diffusion, the optical tweezer may be turned on after the particle that is thrown flies a distance of about 200 μm or less. The acceleration of the optical tweezer that is decelerated may be within an acceleration range for successfully catching the particle without losing.

In operations S1901 and S1905, as the optical tweezer is accelerated or decelerated within an appropriate acceleration range, the loss of a particle may be reduced in a particle manipulation process.

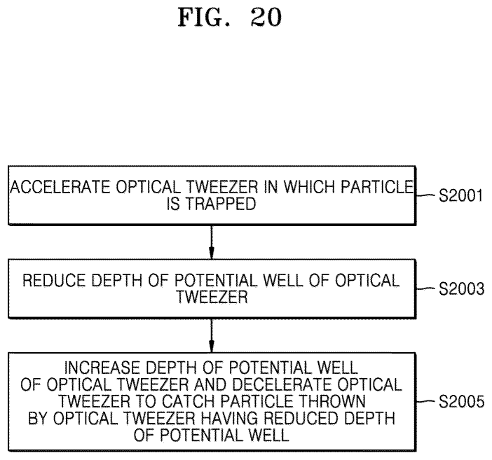

FIG. 20 is a flowchart showing a method of manipulating a particle by using an optical tweezer, according to an embodiment.

In operation S2001, the optical tweezer in which a particle is trapped may be accelerated. The description of operation S1901 may be applied to operation S2001.

In operation S2003, the depth of the potential well of the optical tweezer may be reduced. The depth of the potential well of the optical tweezer may be reduced to 0 by reducing the magnitude of the pulse of the optical modulator to 0. Alternatively, the depth of the potential well of the optical tweezer may be reduced to 0 by stopping the output of a laser source. Accordingly, the optical tweezer may be turned off, and the particle may be thrown by the optical tweezer.

In operation S2005, to catch the particle that is thrown by the optical tweezer in which the depth of the potential well is reduced, the depth of the potential well of the optical tweezer may be increased and the optical tweezer is decelerated. The depth of the potential well of the optical tweezer may be increased by increasing the magnitude of the pulse of the optical modulator. Alternatively, by resuming the output of the laser source, the depth of the potential well of the optical tweezer may be increased. The description of operation S1905 may be applied to operation S2005.

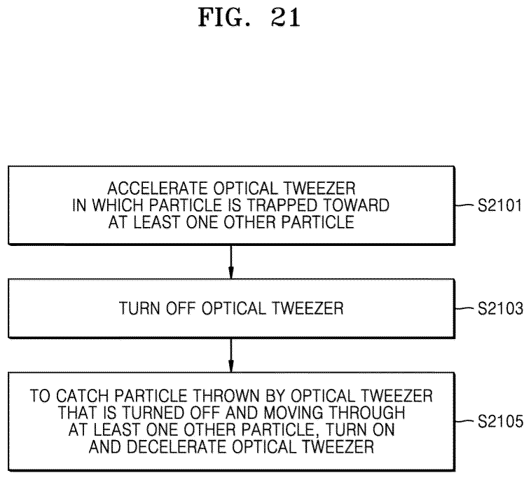

FIG. 21 is a flowchart showing a method of manipulating a particle by using an optical tweezer, according to an embodiment.

In operation S2101, an optical tweezer in which a particle is trapped may be accelerated toward at least one other particle. The at least one other particle may include a plurality of particles. The particles may be arranged in a row. The optical tweezer may be accelerated in a direction in which the particles are arranged in a row. The description of operation S1901 may be applied to operation S2101.

In operation S2103, the optical tweezer may be turned off. The description of operation S1903 may be applied to operation S2103.

In operation S2105, to catch the particle thrown by the optical tweezer that is turned off and moving through the at least one other particle, the optical tweezer may be turned on and decelerated. The optical tweezer may be turned on at a position opposite to the position where the particle was thrown with respect to the at least one other particle. The description of operation S1905 may be applied to operation S2105.

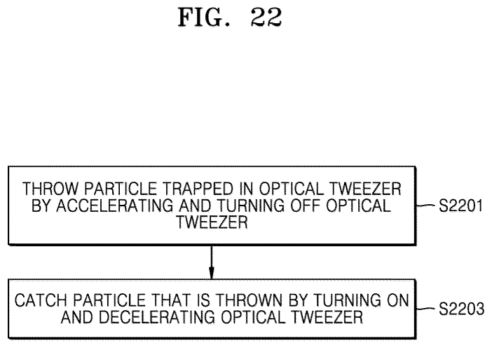

FIG. 22 is a flowchart showing a method of manipulating a particle by using an optical tweezer, according to an embodiment.

In operation S2201, a particle trapped in an optical tweezer may be thrown by accelerating and turning off the optical tweezer. The descriptions of operations S1901 and S1903 may be applied to operation S2201.

In operation S2203, the particle that is thrown may be caught by turning on and decelerating the optical tweezer. The description of operation S2205 may be applied to operation S2203.

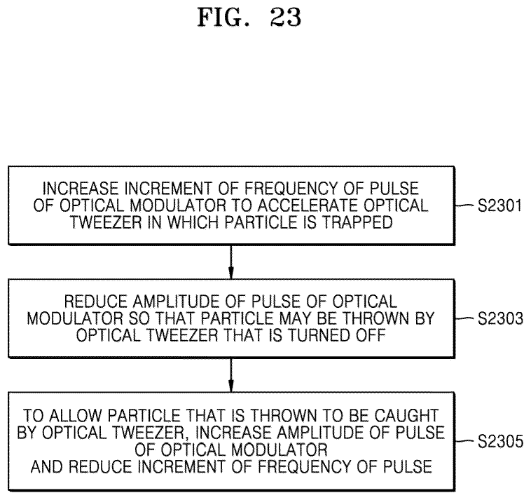

FIG. 23 is a flowchart showing a method of manipulating a particle by using an optical tweezer, according to an embodiment.

In operation S2301, a processor may increase an increment of the frequency of a pulse of an optical modulator to accelerate an optical tweezer in which a particle is trapped.

The traveling direction of a laser beam may be modulated according to the frequency of the pulse of the optical modulator. As the increment of the frequency of the pulse of the optical modulator increases, the laser beam of the optical tweezer may move fast in one direction. Accordingly, the optical tweezer may be accelerated.

In operation S2303, the processor may reduce the amplitude of the pulse of the optical modulator so that a particle may be thrown by the optical tweezer that is turned off. In detail, the processor may reduce the amplitude of the pulse of the optical modulator to 0. Accordingly, the particle may be freed from the optical tweezer to fly.

In operation S2305, to allow the particle that is thrown to be caught by the optical tweezer, the processor may increase the amplitude of a pulse of the optical modulator and reduce the increment of the frequency of the pulse. As the increment of the frequency of the pulse of the optical modulator decreases, the laser beam of the optical tweezer may slowly move in one direction. Accordingly, the optical tweezer may be decelerated.

According to the method described with reference to FIG. 23, as the particle may be thrown or caught by adjusting the pulse of the optical modulator, other additional devices to manipulate the particle are not required.

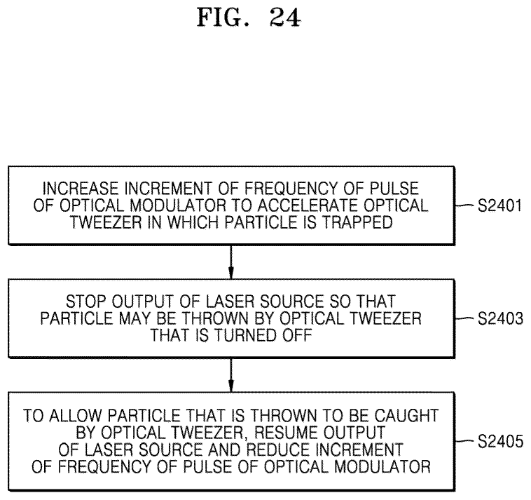

FIG. 24 is a flowchart showing a method of manipulating a particle by using an optical tweezer, according to an embodiment.

In operation S2401, a processor may increase the increment of the frequency of the pulse of the optical modulator to accelerate the optical tweezer in which a particle is trapped. The description of operation S2301 may be applied to operation S2401.

In operation S2403, the processor may stop the output of a laser source so that a particle may be thrown by the optical tweezer that is turned off. As the output of the laser source is stopped, the depth of a potential well of an optical tweezer may be reduced to 0. Accordingly, the particle may be freed from the optical tweezer to fly.

In operation S2405, to allow the particle that is thrown to be caught by optical tweezer, the processor may resume the output of the laser source and reduce an increment of the frequency of a pulse of the optical modulator. As the output of the laser source resumes, the particle may be trapped by a potential well of the optical tweezer. The description of operation S2305 may be applied to operation S2405.

According to the method described with reference to FIG. 24, as the particle may be thrown or caught by adjusting the pulse of the optical modulator and the output of the laser source, other additional devices to manipulate the particle are not required.

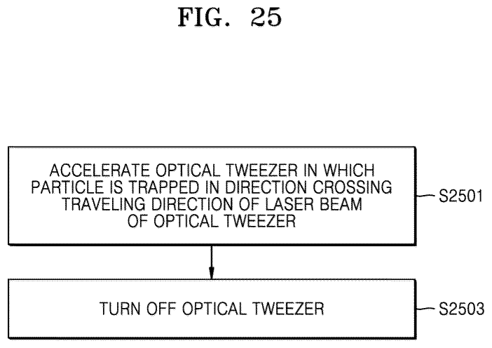

FIG. 25 is a flowchart showing a method of manipulating a particle by using an optical tweezer, according to an embodiment.

In operation S2501, an optical tweezer in which a particle is trapped may be accelerated in a direction crossing a traveling direction of a laser beam of the optical tweezer. The acceleration of a particle in a direction crossing the traveling direction of a laser beam of the optical tweezer, not in the traveling direction of a laser beam of the optical tweezer, is different from the acceleration by hitting a particle by using an optical tweezer, and enables accelerating and throwing a particle based on the velocity of the optical tweezer controlled in a continuous time section. Accordingly, the flight velocity of a particle may be easily controlled by controlling the velocity of the optical tweezer. The acceleration direction of the optical tweezer may be a direction crossing the central axis of the optical tweezer or the traverse direction of the optical tweezer.

In operation S2503, the optical tweezer may be turned off. The relative velocity and displacement of a particle with respect to the optical tweezer may vary depending on the time point when the optical tweezer is turned off. The time point when the optical tweezer is turned off may be set depending on the required relative velocity and displacement of a particle with respect to the optical tweezer.

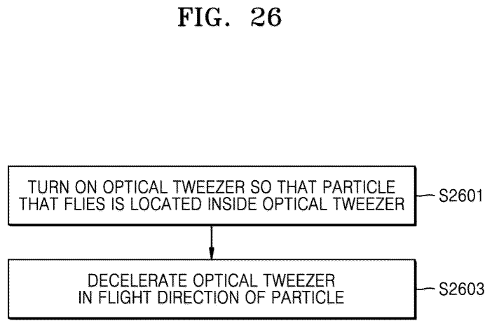

FIG. 26 is a flowchart showing a method of manipulating a particle by using an optical tweezer, according to an embodiment.

In operation S2601, an optical tweezer may be turned on so that a particle that flies may be located inside the optical tweezer. The flight direction of a particle and the traveling direction of a laser beam of the optical tweezer that is turned on may cross each other.

In operation S2603, the optical tweezer may be decelerated in the flight direction of a particle. Catching a particle that flies using an optical tweezer, not by stopping the particle that flies by colliding against an object, may enable easy control of a particle catching position by controlling the turn-on position of the optical tweeze. Not catching a particle by simply turning on an optical tweezer, but catching a particle by decelerating an optical tweezer may increase a particle catching success probability. The deceleration direction of an optical tweezer may be a direction crossing the traveling direction of a laser beam of the optical tweezer, a direction crossing the central axis of the optical tweezer, or the traverse direction of the optical tweezer.

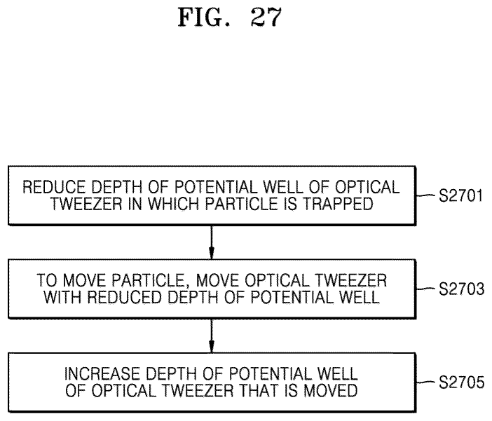

FIG. 27 is a flowchart showing a method of manipulating a particle by using an optical tweezer, according to an embodiment.

In operation S2701, the depth of a potential well of an optical tweezer in which a particle is trapped may be reduced. The particle may be in a state of being fixed or dragged by the optical tweezer. The depth of the potential well of the optical tweezer may be reduced to be greater than the minimum value at which a particle may be dragged without missing.

In operation S2703, to move a particle, an optical tweezer with a reduced depth of a potential well may be moved. The optical tweezer may be moved such that another particle trapped by another optical tweezer is located in a path of the particle. Alternatively, the optical tweezer may be moved such that another optical tweezer in which another particle is trapped may be located in a path of the particle. The other particle may be in a state of being fixed or dragged by the other optical tweezer. As the particle is dragged by the optical tweezer, the particle may move through the other particle trapped by the other optical tweezer or the other optical tweezer in which the other particle is trapped. The depth of the potential well of the optical tweezer may be less than the maximum value at which the optical tweezer prevents the other particle from escaping from the other optical tweezer.

In operation S2705, the depth of the potential well of the optical tweezer that is moved may be increased. After the particle moves through the other particle or the other optical tweezer, the depth of the potential well of the optical tweezer may be increased.

Through operations S2701, S2703, and S2705, while a particle moves through another particle or another optical tweezer, the depth of the potential well of the optical tweezer may be maintained to be relatively low. Likewise, while a particle moves through another particle or another optical tweezer, the depth of the potential well of the other optical tweezer may be maintained to be relatively low. In detail, while a particle moves through another particle or another optical tweezer, the depth of the potential well of the other optical tweezer may be less than the maximum value at which the other optical tweezer may prevent the particle from escaping from the optical tweezer. Furthermore, the depth of the potential well of the other optical tweezer may be greater than the minimum value at which the other particle is not lost.

While a particle moves through another particle or another optical tweezer, by reducing the depths of the potential wells of the optical tweezer and the other optical tweezer, a probability of losing the other particle by the optical tweezer and a probability of losing the particle by the other optical tweezer 1812 may be reduced.

The embodiments described above may be performed, without any specific description, by the system described with reference to FIGS. 12 to 14. Furthermore, the embodiment described above in which a particle is thrown and caught by one optical tweezer may be modified into an embodiment in which a particle is thrown by one optical tweezer and caught by another optical tweezer. Furthermore, in the embodiments described above, in the number expressed as 94(3)%, the number in parenthesis indicates the magnitude of an error bar. Furthermore, the method according to some embodiments described above may be used in the rearrangement of a particle array for quantum computing.

Various embodiments of the disclosure may be implemented or supported by one or more computer programs, and the computer programs may be formed of computer-readable program code, and included in a computer-readable medium. In the disclosure, the “application” and “program” may indicate one or more computer programs, software components, instruction sets, procedures, functions, objects, classes, instants, related data, or part thereof, which are suitable for implementation in the computer-readable program code. A “computer-readable program code” may include various types of computer code including source code, object code, and executable code. A “computer-readable medium” may include various types of media to be accessed by a computer, such as read only memory (ROM), random access memory (RAM), hard disk drives (HDD), compact discs (CD), digital video discs (DVD), or various types of memories.

Furthermore, a device-readable storage medium may be provided in the form of a non-transitory storage medium. The “non-transitory storage medium” may mean a tangible device, and may exclude wired, wireless, optical, or other communication links for transmitting temporary electrical or other signals. The “non-transitory storage medium” does not distinguish whether data is stored semi-permanently or temporarily on the storage medium. For example, the “non-transitory storage medium” may include a buffer in which data is temporarily stored. A computer-readable storage medium may be a useable medium that is accessible by a computer and may include all of volatile and non-volatile media and separable and inseparable media. A computer-readable medium includes a medium on which data can be permanently stored and a medium on which data can be stored and later overwritten, such as rewritable optical discs or erasable memory devices.

According to an embodiment, the method according to various embodiments disclosed in the present document may be provided by being included in a computer program product. A computer program product as goods may be dealt between a seller and a buyer. A computer program product may be distributed in the form of a device-readable storage medium (e.g., a compact disc read only memory (CD-ROM)), or through an application store or directly online between two user devices (e.g., smartphones) (e.g., download or upload) For online distribution, at least part of a computer program product (e.g., a downloadable application) may be at least temporarily stored or generated on a device-readable storage medium such as a manufacturer's server, a server of the application store, or a memory of a relay server.

The above descriptions of the disclosure is for an example, and it will be understood that one of ordinary skill in the art to which the disclosure pertains can easily modify the disclosure into other detailed form without changing the technical concept or essential features of the disclosure. Thus, the above-described embodiments are exemplary in all aspects and should not be for purposes of limitation. For example, each constituent element described to be a single type may be embodied in a distributive manner.

The scope of the disclosure is defined not by the detailed description of the disclosure but by the appended claims, and all changes and modifications introduced from the concept and scope of the claims and the equivalent concept thereof will be construed as being included in the disclosure.

According to the method and system for manipulating a particle by using an optical tweezer, according to the technical concept of the disclosure, a particle may be manipulated to move through another particle on a path. Accordingly, a particle array may be arranged or rearranged by an efficient method.

Furthermore, as the optical tweezer is accelerated or decelerated in an appropriate acceleration range, the loss of a particle may be reduced in a particle manipulation process.

Furthermore, as a particle may be thrown or caught by adjusting the pulse of an optical modulator, other additional devices to manipulate the particle are not required.

Furthermore, as a particle is caught by decelerating the optical tweezer, the particle may be caught with a high success probability.

Furthermore, the acceleration of a particle in a direction crossing the traveling direction of a laser beam of the optical tweezer, not in the traveling direction of a laser beam of the optical tweezer, is different from the acceleration by hitting a particle by using an optical tweezer, and enables accelerating and throwing a particle based on the velocity of the optical tweezer controlled in a continuous time section. Accordingly, the flight velocity of a particle may be easily controlled by controlling the velocity of the optical tweezer.

It should be understood that embodiments described herein should be considered in a descriptive sense only and not for purposes of limitation. Descriptions of features or aspects within each embodiment should typically be considered as available for other similar features or aspects in other embodiments.

While one or more embodiments have been described with reference to the figures, it will be understood by those of ordinary skill in the art that various changes in form and details may be made therein without departing from the spirit and scope of the disclosure as defined by the following claims.

What is claimed is:

1. A method of manipulating a particle by using an optical tweezer, the method comprising:
accelerating the optical tweezer in which the particle is trapped;
turning off the optical tweezer; and
to catch the particle thrown by the optical tweezer that is turned off, turning on and decelerating the optical tweezer.

2. The method of claim 1, wherein the accelerating of the optical tweezer comprises accelerating the optical tweezer in a direction crossing a traveling direction of a laser beam of the optical tweezer.

3. The method of claim 1, wherein the accelerating of the optical tweezer comprises accelerating the optical tweezer such that a magnitude of acceleration of the optical tweezer is less than or equal to a value obtained by dividing a depth of a potential well of the optical tweezer by a product of a radial distance of the optical tweezer and a mass of the particle.

4. The method of claim 1, wherein the accelerating of the optical tweezer comprises accelerating the optical tweezer at an acceleration in a range of about 4.80*10² m/s² to about 1.20*10⁶ m/s².

5. The method of claim 1, wherein the turning on and decelerating of the optical tweezer comprises decelerating the optical tweezer in a direction crossing a traveling direction of a laser beam of the optical tweezer.

6. The method of claim 1, wherein the turning on and decelerating of the optical tweezer comprises turning on the optical tweezer at a position away from a position where the optical tweezer is turned off in a direction in which the particle is thrown.

7. The method of claim 1, wherein the turning on and decelerating of the optical tweezer comprises turning on the optical tweezer after the particle that is thrown flies a preset distance, the preset distance being aout 200 μm or less.

8. The method of claim 1, wherein the turning on and decelerating of the optical tweezer comprises, turning on the optical tweezer after the particle that is thrown flies for a preset time, the preset time being about 18 μs or less.

9. The method of claim 1, being performed in a pressure environment of 1×10⁻¹¹ torr or less.

10. The method of claim 1, wherein the particle comprises at least one of a neutral particle, a Rydberg atom, or a dielectric particle.

11. The method of claim 1, wherein the particle comprises at least one of Rb-87, Rb-85, Cs, or Li.

12. A method of manipulating a particle by using an optical tweezer, the method comprising:
accelerating the optical tweezer in which the particle is trapped;
reducing a depth of a potential well of the optical tweezer; and
to catch the particle thrown by the optical tweezer in which the depth of the potential well is reduced, increasing the depth of the potential well of the optical tweezer and decelerating the optical tweezer.

13. The method of claim 12, wherein the reducing of the depth of the potential well of the optical tweezer comprises
reducing the depth of the potential well of the optical tweezer to 0.

14. A method of manipulating a particle by using an optical tweezer, the method comprising:
accelerating the optical tweezer, in which the particle is trapped, toward at least one other particle;
turning off the optical tweezer; and
to catch the particle thrown by the optical tweezer that is turned off and moving through the at least one other particle, turning on and decelerating the optical tweezer.

15. The method of claim 14, wherein the at least one other particle comprises a plurality of particles arranged in a row, and
the accelerating of the optical tweezer comprises accelerating the optical tweezer in a direction in which the plurality of particles are arranged in a row.

16. The method of claim 14, wherein the turning on and decelerating of the optical tweezer comprises, turning on the optical tweezer at a position opposite to a position where the optical tweezer is turned off with respect to the at least one other particle.

17. A method of manipulating a particle by using an optical tweezer, the method comprising:
throwing the particle trapped in the optical tweezer by accelerating and turning on the optical tweezer; and
catching the particle that is thrown by turning on and decelerating the optical tweezer.

18. A system for manipulating a particle by using an optical tweezer, the system comprising:
an optical modulator configured to control the optical tweezer by interfering a laser beam with a pulse; and
a processor configured to control the optical modulator,
wherein the processor is further configured to:
increase an increment of a frequency of the pulse of the optical modulator to accelerate the optical tweezer in which the particle is trapped;
reduce an amplitude of the pulse of the optical modulator to allow the particle to be thrown by the optical tweezer that is turned off; and
increase the amplitude of the pulse of the optical modulator and reduce the increment of the frequency of the pulse to allow the particle that is thrown to be caught by the optical tweezer.

19. The system of claim 18, wherein the processor is further configured to maintain the increment of the frequency of the pulse of the optical modulator constant, while the amplitude of the pulse of the optical modulator is reduced.

20. The system of claim 18, wherein the processor is further configured to reduce the amplitude of the pulse of the optical modulator to 0 to allow the particle to be thrown by the optical tweezer that is turned off.

21. The system of claim 18, wherein the optical modulator comprises an acousto-optic deflector (AOD).

22. A system for manipulating a particle by using an optical tweezer, the system comprising:
a laser source;
an optical modulator configured to control the optical tweezer by interfering a laser beam output from the laser source with a pulse; and
a processor configured to control the laser source and the optical modulator, wherein the processor is further configured to:
increase an increment of a frequency of a pulse of the optical modulator to accelerate the optical tweezer in which the particle is trapped;
stop an output of the laser source to allow the particle to be thrown by the optical tweezer that is turned off; and
resume the output of the laser source and reduce the increment of the frequency of the pulse to allow the particle that is thrown to be caught by the optical tweezer.

23. A method of throwing a particle by using an optical tweezer, the method comprising:
accelerating the optical tweezer in which the particle is trapped in a direction crossing a traveling direction of a laser beam of the optical tweezer; and
turning off the optical tweezer.

24. A method of catching, by using an optical tweezer, a particle that flies, the method comprising:
turning on the optical tweezer to allow the particle that flies to be located therein;
and decelerating the optical tweezer in a flight direction of the particle.

25. A method of manipulating a particle by using an optical tweezer, the method comprising:
reducing a depth of a potential well of the optical tweezer in which the particle is trapped;
moving the optical tweezer with a reduced depth of the potential well to move the particle; and
increasing the depth of the potential well of the optical tweezer that is moved.
